(19) United States
(12) Patent Application Publication
(10) Pub. No.: US 2025/0035120 A1
(43) Pub. Date: Jan. 30, 2025

(54) METHOD AND APPARATUS FOR DETECTING HYDRAULIC SHOCK

(71) Applicant: GRUNDFOS HOLDING A/S, Bjerringbro (DK)

(72) Inventors: Torben NIELSEN, Bjerringbro (DK); Jesper Thørring DAMGAARD, Bjerringbro (DK)

(21) Appl. No.: 18/716,469

(22) PCT Filed: Nov. 16, 2022
(86) PCT No.: PCT/EP2022/082061

§ 371 Date: Jun. 4, 2024

(30) Foreign Application Priority Data
Nov. 17, 2021 (DK) PA202170569

(51) Int. Cl. F04D 15/00; G01H 1/00

(52) U.S. Cl. CPC F04D 15/0088; G01H 1/003

(57) ABSTRACT

Disclosed herein are embodiments of an apparatus for detecting hydraulic shock events in a fluid system, the apparatus comprising a vibration sensor operable to output a vibration sensor signal indicative of sensed vibrations of one or more components of the fluid system, and a processing unit configured to: obtain a vibration velocity signal from the vibration sensor signal, the vibration velocity signal being indicative of a vibration velocity of the one or more components of the fluid system; detect one or more peaks in the vibration velocity signal; and classify one or more of the detected peaks as a hydraulic shock event.

### TECHNICAL FIELD

The present disclosure relates to a method and apparatus for detecting hydraulic shock in a fluid system.

### BACKGROUND

Hydraulic shock, often also referred to as water hammer or fluid hammer, refers to a pressure surge or wave caused when a fluid in motion, in particular a liquid, is forced to suddenly stop, change direction or otherwise experience a sudden change in momentum. Hydraulic shock may e.g. occur in a fluid system when a valve in a pipe closes suddenly causing a pressure wave to propagate along the pipe.

Fluid systems often include one or more pumps and hydraulic shock is a common cause of failure in pumps. A pump continuously experiencing hydraulic shock may eventually suffer from fatigue wear. If a hydraulic shock event is potent enough, even a single event can damage the pump. Aside from the pump, hydraulic shock events can also cause serious damage to other parts of a fluid system, e.g. to sensors and/or the like. Hydraulic shock may also cause noise and vibration in a fluid system and may even result in pipe rupture or collapse.

On this background, it is generally desirable to be able to monitor the frequency and/or severity of occurrences of hydraulic shock events. Based on such monitoring, the operating procedures of a fluid system may be adjusted, or other countermeasures may be implemented, in order to avoid or at least reduce the frequency and/or severity of future hydraulic shock events.

It is desirable that the detection of hydraulic shock can be conducted without sensors that require direct contact to the fluid being transported in the fluid system, in particular without pressure sensors measuring the fluid pressure. This is desirable, because sensors that need to be in contact with the transported fluid are at risk of being damaged by the hydraulic shock events they are intended to detect. Moreover, without reliance on such sensors, the detection setup is easier to implement and easier to maintain.

US 2021/215645A1 discloses a mechanism for generating an alert of a water hammer event in a steam pipe, the mechanism comprising: sampling an accelerometer coupled to a steam pipe to provide accelerometer data; determining that the accelerometer data meets or exceeds a threshold; and generating an alert that a water hammer event has occurred based at least in part on the accelerometer data.

On this background, it remains desirable to provide an improved or at least an alternative method and/or apparatus for detecting hydraulic shock in a fluid system. It is further generally desirable to provide a method and/or apparatus for detecting hydraulic shock events that is accurate, robust, fast and cost efficient.

### SUMMARY

According to one aspect, disclosed herein are embodiments of an apparatus for detecting hydraulic shock events in a fluid system, the apparatus comprising a vibration sensor operable to output a vibration sensor signal indicative of sensed vibrations of one or more components of the fluid system, and a processing unit configured to:
obtain a vibration velocity signal from the vibration sensor signal, the vibration velocity signal being indicative of a vibration velocity of the one or more components of the fluid system;
detect one or more peaks in the vibration velocity signal; and
classify one or more of the detected peaks as a hydraulic shock event.

The inventors have realized that the hydraulic shock events in a fluid system can be detected and classified more reliably based on detected peaks in a vibration velocity signal rather than detecting peaks in another type of vibration signal, e.g. an acceleration signal. In particular, the severity of a water hammer event can be detected more reliably, which facilitates classification of the detected peaks as a hydraulic shock event, e.g. as a hydraulic shock event of at least a minimum severity.

To this end, in some embodiments, the vibration sensor is a vibration velocity sensor configured to sense vibration velocity. Accordingly, the vibration sensor signal represents a vibration velocity signal and obtaining the vibration velocity signal comprises receiving the vibration velocity signal from the vibration sensor.

In other embodiments, the vibration sensor is an accelerometer operable to sense accelerations of one or more components of the fluid system, thereby providing a stable means of measuring vibrations. Accordingly, the vibration sensor signal represents a vibration acceleration signal and obtaining the vibration velocity signal comprises receiving the vibration acceleration signal from the vibration sensor and transforming the received vibration acceleration signal into a vibration velocity signal, e.g. by integrating the vibration acceleration signal with respect to time.

In some embodiments, the apparatus is configured to detect a hydraulic shock event responsive to detecting a peak in the vibration velocity signal that fulfills one or more trigger criteria, in particular one or more trigger criteria indicative of a significance of the detected peak or the severity of the detected hydraulic shock event, thus avoiding raising unnecessary alerts.

Examples of trigger criteria include a magnitude, in particular a magnitude of the detected peak exceeding a minimum threshold. Further examples of trigger criteria include the duration and/or attack time and/or decay time of a detected peak being smaller than a corresponding threshold or falling inside a certain range. Alternatively or additionally, other trigger criteria indicative of the significance of a peak and/or the severity of the hydraulic shock event may be used, such as other attack and/or decay characteristics. The magnitude of a detected peak may be determined as a peak amplitude, e.g. compared to a baseline level of the signal in which the peak has been detected. The baseline level may be an average of the signal over a suitable time window. Other measures of a peak magnitude include the area under the detected peak. The inventors have found that a computationally efficient, robust and reliable detection of hydraulic shock events can be obtained based on the detection of peaks in the vibration velocity signal that have a magnitude exceeding a predetermined threshold.

In some embodiments, the processing unit is further configured to compute a measure of severity of the hydraulic shock event. A reliable measure of the severity of a hydraulic shock event is the magnitude of the pressure wave propagating through the fluid. However, it is desirable to assess the severity of a hydraulic shock event without the need for pressure measurements. Accordingly, in some embodiments, the processing unit is further configured to compute a measure of severity of the hydraulic shock event from the vibration velocity signal. In particular, the inventors have found that the magnitude of the measured vibration velocity is strongly correlated to the peak pressure of the pressure wave during a hydraulic shock event and, hence, may serve as another reliable measure of the severity of the hydraulic shock event, in particular a measure that does not require pressure measurements. Accordingly, the computed measure of the severity of the hydraulic shock event may be a measure of the magnitude of the detected peak in the vibration velocity signal, e.g. the amplitude of the peak or another measure of the magnitude of the peak as described above in the context of the trigger condition for classifying a detected peak as a hydraulic shock event. The computation of the measure of severity may be performed as part of the classification of a detected peak as a hydraulic shock event. In particular, the classification may be based on the computed measure of severity. Alternatively, the classification of a detected peak as a hydraulic shock event may be performed separately and independently from the computation of the measure of severity. For example, the classification may use a trigger criterion that is not based on the severity of the hydraulic shock event.

Generally, the vibration acceleration signal may be a signal representing sensed accelerations associated with a vibration as a function of time. Similarly, the vibration velocity signal may be a signal representing a vibration velocity of the sensed vibrations as a function of time. The vibration velocity is the rate of change in the position of the component whose vibrations are sensed by the vibration sensor. Vibration velocity may be expressed as a displacement per unit time, e.g. expressed in units of meters per second. In particular, the vibration acceleration signal may be an oscillating acceleration signal. Similarly, the vibration velocity signal may be an oscillating velocity signal. In some embodiments, the transforming comprises integrating the acceleration signal into a vibration velocity signal.

In some embodiments, obtaining the vibration velocity signal comprises a high-pass filtering so as to suppress slow variations of the vibration velocity signal, i.e. the vibration velocity signal may be a high-pass filtered vibration velocity signal, in particular a high-pass filtered oscillating vibration velocity signal. In embodiments where the vibration sensor is an accelerometer, the high-pass filtering may be performed on the oscillating acceleration signal and/or on the oscillating vibration velocity signal.

In some embodiments, the vibration velocity signal may be a vibration velocity amplitude signal indicative of an amplitude of the oscillating vibration velocity signal. In particular, the vibration velocity amplitude signal may be indicative of an envelope of the oscillating vibration velocity signal, in particular of the high-pass filtered oscillating vibration velocity signal.

Obtaining the vibration velocity signal may thus comprise performing an envelope computation to obtain a vibration velocity amplitude signal. In particular, in embodiments where the vibration sensor is an accelerometer generating a vibration acceleration signal, obtaining the vibration velocity signal may comprise integrating the vibration acceleration signal and performing an envelope computation to obtain a vibration velocity amplitude signal. The integration and/or the envelope computation may include a high-pass filtering and/or another type of filtering. The processing unit may thus be configured to:
detect one or more peaks in the vibration velocity amplitude signal,
compute respective magnitudes of the detected one or more peaks, and
classify one or more of the detected peaks as a hydraulic shock event responsive to the computed magnitude exceeding a threshold, in particular a predetermined and/or an adaptively and automatically determined threshold.

In some embodiments, the apparatus is configured to detect a hydraulic shock event based on the vibration velocity signal alone, in particular based on detected peaks in the obtained vibration velocity signal. In other embodiments, the apparatus is configured to detect a hydraulic shock event based on the vibration velocity signal in combination with one or more additional detected indicators of a hydraulic shock event, e.g. in combination with a detected variation in the pump speed of a pump of the fluid system and/or in combination with a detected variation in the motor frequency of a pump motor driving a pump of the fluid system. To this end, the inventors have realized that the pressure impulse of a hydraulic shock event typically applies so much energy to the pump that the pump controller cannot keep the rotational speed of the pump and/or the motor frequency, steady. Variations in the pump speed and/or motor frequency may thus be used as an additional indicator for a hydraulic shock event.

In particular, in some embodiments, the fluid system comprises a pump assembly, the pump assembly comprising a pump, in particular a centrifugal pump, and a pump motor, in particular an electrical pump motor. The apparatus further comprises means for monitoring a pump speed of the pump and/or a motor frequency of the pump motor. The processing unit may thus be configured to:
detect a variation in the monitored pump speed and/or motor frequency; and
classify one or more of the detected peaks in the vibration velocity signal as a hydraulic shock event, responsive to detecting a corresponding variation in the monitored pump speed and/or motor frequency.

In particular, a detected peak in the vibration velocity signal allows for a reliable detection of the severity or significance of a detected hydraulic shock event while the concurrent detection of variations in the monitored pump speed and/or motor frequency allows for a reliable elimination of false positive detections. The latter may otherwise occur in situations where vibrations of components of the fluid systems have causes other than pressure waves in the fluid being pumped through the fluid system. Such other causes may e.g. be an external mechanical impact on a component of the fluid system, such as banging, hammering or the like.

The inventors have found that a computationally efficient, robust and reliable detection of hydraulic shock events can be obtained based on the detection of peaks in the vibration velocity signal, which peaks have a magnitude exceeding a predetermined threshold, when the apparatus also detects a corresponding peak/fluctuation in the monitored pump speed and/or motor frequency.

The processing unit may be configured to classify a detected peak in the vibration velocity signal as a hydraulic shock event responsive to the detected peak in the vibration velocity signal having a predetermined temporal relationship with the detected variation in the monitored pump speed and/or motor frequency. To this end, the predetermined temporal relationship may be chosen so as to detect a common cause of the detected peak in the vibration velocity signal and the detected variation in the monitored pump speed and/or motor frequency. The predetermined temporal relationship between the peak in the vibration velocity signal and the detected variation in the monitored pump speed and/or motor frequency may be the peak in the vibration velocity signal and the detected variation in the monitored pump speed and/or motor frequency occurring within one or more predetermined time windows from each other.

For example, when the vibration sensor is positioned on or in close proximity to the pump assembly whose pump speed and/or motor frequency is monitored, the processing unit may be configured to detect a hydraulic shock event responsive to a detected peak in the obtained vibration velocity signal being substantially simultaneous with the detected variation in the monitored pump speed and/or motor frequency, i.e. within a short time window of each other, e.g. within 1 s of each other or even within a smaller time window. When the vibration sensor is positioned spaced apart from the pump assembly whose pump speed and/or motor frequency is monitored, e.g. on a pipe or another component of the fluid system located at a distance from the pump assembly, the processing unit may be configured to detect a hydraulic shock event responsive to a detected variation in the monitored pump speed and/or motor frequency which precedes or is delayed compared to the detected peak in the vibration velocity signal, in particular precedes or is delayed corresponding to the propagation time of a pressure wave between the location of the vibration sensor to the pump assembly. This may be achieved by detecting peaks that occur within a larger time window from each other. Alternatively, this may be achieved by detecting a variation in the monitored pump speed and/or motor frequency that occurs within one of two shorter time windows relative to a peak in the vibration velocity signal, where one of the time windows precedes the peak in the vibration velocity signal by a predetermined offset and the other time window is delayed relative to the peak in the vibration velocity signal by a predetermined offset.

In some embodiments, the predetermined time window may be selected large enough so as to cover a number of possible placements of the vibration sensor, e.g. by detecting peaks that occur within 0.5 s, such as within 1 s, such as within 2 s, such as within 5 s, or within another suitable time window from each other. In other embodiments, the size and/or offset of the time window or time windows may be chosen for a particular system configuration, e.g. based on a particular placement of the sensors relative to each other.

In some embodiments, the pump comprises a shaft that is configured to be driven by the pump motor. In some embodiments, the pump comprises an impeller that is rotationally driven by the shaft. Accordingly, the pump speed may be measured as a rotational speed of the shaft and/or of the impeller.

In some embodiments, the pump motor is an electric motor driven by a periodically varying magnetic field, in particular where a rotor of the motor is driven by a periodically varying magnetic field. To this end, the pump motor may be driven by a periodically varying electric drive current. The motor frequency may thus be measured as a frequency of the periodically varying magnetic field and/or as a frequency of the drive current, or as another suitable measure of the motor frequency. The electrical motor may comprise a stator and a rotor and the varying magnetic field may be a varying stator magnetic field. The motor may be driven by a variable frequency drive or another suitable motor drive providing the drive current for the motor.

In most situations, there may be a one-to-one correspondence between the motor frequency and the pump speed. However, in some situations, e.g. when there is an amount of slip between the motor and the shaft driving the pump, the motor frequency and the pump speed may differ. Nevertheless, a hydraulic shock event typically affects the pump speed, in particular the rotational speed of the impeller or of the shaft driving the impeller, and also affects the motor frequency of the pump motor. Therefore, a detected variation in the pump speed and/or the motor frequency can each serve as a reliable indicator of a hydraulic shock event, in particular an indicator that is suitable for eliminating false positive classifications of detected vibration events. In some embodiments, the apparatus may even monitor both the pump speed and the motor frequency.

Accordingly, in some embodiments, the processing unit is configured to monitor the vibration velocity signal and a signal indicative of the pump speed and/or motor frequency, and to detect peaks/fluctuations in both signals. The processing unit is configured to detect a hydraulic shock event as the occurrence of peaks/fluctuations, in particular significant peaks/fluctuations, in both signals where the peaks/fluctuations have a predetermined temporal relationship with each other, e.g. occurring simultaneous or in another predetermined temporal alignment. The processing unit may be configured to determine the detected peaks/fluctuations as being significant peaks/fluctuations based on one or more criteria, such as one or more predetermined criteria. Examples of such criteria include the magnitude of the detected peaks/fluctuations exceeding a threshold. Generally, the magnitude of a peak/fluctuation may be measured as an amplitude of the peak/fluctuation, as an area under the peak/fluctuation (or under an envelope of the peak/fluctuations) or another suitable measure indicative of the magnitude of a peak/fluctuation. Alternative or additional examples of criteria of the significance of a peak may be based on one or more other features of the detected peaks/fluctuations, e.g. of the attack characteristics or decay characteristics of the detected peaks/fluctuations, and/or the like.

In some embodiments, the means for sensing the motor frequency of the pump motor includes a magnetic field sensor and/or a sensor for measuring an electrical drive current of the motor. The magnetic field sensor may be configured, in particular positioned, such that the magnetic field sensor measures the varying magnetic field for driving the electric motor, in particular for driving the rotor of the electric motor. The sensor for sensing the electrical drive current may be integrated into the a motor drive circuit or it may be a separate sensor for measuring the electrical drive current or a quantity from which the electrical drive current can be derived.

The vibration sensor and the magnetic field sensor may be provided as separate sensor units or they may be integrated into a single sensor unit having a housing that accommodates the magnetic field sensor and the vibration sensor. Optionally, the sensor unit may include one or more further sensors and/or signal processing circuitry. Examples of further sensors include a temperature sensor. Accordingly, such an integrated sensor unit may easily be installed. For example, an existing pump assembly may easily be retrofitted with such a sensor unit. The sensor unit may be communicatively connected via a wired or wireless connection to the data processing unit.

The pump speed, in particular the shaft speed or the impeller speed, may be represented as a frequency, e.g. number of rotations per unit time. In some embodiments, the means for monitoring the pump speed includes a tachometer or other sensor configured to measure the rotational speed of the impeller or of a shaft driving the impeller.

The detected variation may be a peak or fluctuation, in particular a sudden fluctuation, in the monitored pump speed and/or motor frequency, in particular a peak or fluctuation having a duration and/or magnitude consistent with a hydraulic shock event. Here the term sudden fluctuation refers to fluctuations on a time scale consistent with hydraulic shock events. Typical hydraulic shock events occur on a time scale of about 100 ms. A pressure impulse associated with a hydraulic shock event may bounce back and forth in a system and go on for several seconds, e.g. up to about 5-10 seconds, i.e. the detected fluctuations of the pump speed and/or motor frequency may have a duration consistent with these time scales.

The apparatus may be configured to detect a hydraulic shock event responsive to detecting a variation in the monitored pump speed and/or motor frequency that fulfills one or more trigger criteria and/or that is temporally aligned with a corresponding vibration event. Examples of trigger criteria include a magnitude, in particular an amplitude, of the detected variation exceeding a minimum threshold. Further examples of trigger criteria include the duration and/or attack time and/or decay time of a detected variation being smaller than a corresponding threshold and/or falling inside a certain range. Alternatively or additionally, other trigger criteria indicative of the significance of a peak may be used.

The inventors have found that a computationally efficient, robust and reliable detection of hydraulic shock events can be obtained based on the detection of fluctuations, in particular sudden fluctuations, of the monitored pump speed and/or motor frequency, the fluctuations having a magnitude exceeding a predetermined threshold and being temporally aligned with a corresponding detected vibration event.

In some embodiments, the apparatus may be configured to obtain a pump speed and/or motor frequency signal indicative of the monitored pump speed and/or motor frequency as a function of time. In some embodiments the apparatus may further be configured to perform a filtering of the obtained pump speed and/or motor frequency signal. In some embodiments, the filtering is or includes a high-pass filtering so as to suppress slow variations of the pump speed and/or motor frequency signal. Alternatively or additionally, the filtering may include a low-pass filtering, a band-pass filtering and/or another type of filtering.

The apparatus, in particular the processing unit, may further be configured to:
detect fluctuations in the pump speed and/or motor frequency signal, in particular in the filtered, e.g. high-pass filtered, pump speed and/or motor frequency signal,
compute a magnitude of the detected fluctuation, and
classify one or more of the detected peaks in the vibration velocity signal as a hydraulic shock event, responsive to detecting a corresponding variation in the monitored pump speed and/or motor frequency, the detected variation having a computed magnitude exceeding a threshold, in particular a predetermined and/or an adaptively and automatically determined threshold.

The apparatus may detect the fluctuations by computing an envelope signal of the pump speed and/or motor frequency signal, in particular the filtered, e.g. high-pass filtered, pump speed and/or motor frequency signal, and to detect peaks in the computed envelope signal.

Generally, the trigger criteria based on the vibration velocity signal and/or based on the pump speed and/or motor frequency signal that are used for detecting hydraulic shock events may be predetermined, in particular selected so as to configure the sensitivity of the hydraulic shock detection while reducing the number of false positive detections. This may e.g. be done during an initial calibration period based on speed data observed for a particular fluid system. While the detection of hydraulic shock events has been found to be efficient, robust and reliable when based on predetermined trigger criteria, e.g. based on the magnitude or other measure of significance of the peaks, in other embodiments the apparatus may apply more complex techniques for analyzing the detected speed variations, e.g. based on machine-learning so as to classify a detected variation as caused by a hydraulic shock event or by other causes.

The processing unit may further be configured to compute a measure of severity of the detected hydraulic shock event, in particular from the detected peak in the vibration velocity signal. Examples of suitable measures of severity include the computed magnitude of the detected peak, the duration, the attack time or the decay time of the detected peak, or a combination of more than one such criteria. The one or more measures of severity may be computed from the detected fluctuations/peaks in the pump speed and/or motor frequency signal and/or from the detected peaks in the vibration velocity signal or from a combination of both.

Generally, detecting a hydraulic shock event may comprise creating a hydraulic shock event alert, optionally including the computed measure of severity and/or other information, such as the time of occurrence, of the detected hydraulic shock event. Creating the hydraulic shock event alert may include outputting a hydraulic shock event alert via a user-interface, outputting/sending an alert signal via a data communications interface, and/or logging the hydraulic shock event alert.

The present disclosure relates to different aspects, including the apparatus described above and in the following, further methods, systems, devices and product means, each yielding one or more of the benefits and advantages described in connection with one or more of the other aspects, and each having one or more embodiments corresponding to the embodiments disclosed in connection with one or more of the other aspects described herein and/or as disclosed in the appended claims.

In particular, another aspect disclosed herein relates to embodiments of a computer-implemented method for detecting hydraulic shock events in a fluid system, the method comprising:
obtaining a vibration velocity signal, the vibration velocity signal being indicative of a vibration velocity of vibrations of one or more components of the fluid system;
detecting one or more peaks in the vibration velocity signal; and
classifying one or more of the detected peaks as a hydraulic shock event.

In particular, obtaining the vibration velocity signal may comprise receiving a vibration acceleration signal indicative of sensed accelerations of the one or more components of the fluid system, and transforming the received vibration acceleration signal into the vibration velocity signal, the vibration velocity signal being indicative of a vibration velocity of the one or more components of the fluid system. Alternatively, obtaining the vibration velocity signal may comprise receiving the vibration velocity signal form a vibration velocity sensor configured to sense a velocity of vibrations of the one or more components of the fluid system

It is noted that features of various embodiments of the computer-implemented method described herein may be implemented at least in part in software or firmware and carried out on a data processing unit or other data processing system caused by the execution of program code means such as computer-executable instructions. Alternatively, the features of the computer-implemented method may be implemented by an otherwise suitably configured data processing unit.

Accordingly, another aspect disclosed herein relates to embodiments of a data processing unit configured to perform the acts of the computer-implemented method described herein. To this end, the data processing unit may have stored thereon program code configured to cause, when executed by the data processing unit, the data processing unit to perform the acts of the method described herein. The data processing unit may include a memory for storing a suitable computer program.

Here and in the following, the term data processing unit comprises any circuit and/or device suitably adapted to perform the above functions. The term data processing unit comprises general- or special-purpose programmable microprocessors, Digital Signal Processors (DSP), Application Specific Integrated Circuits (ASIC), Programmable Logic Arrays (PLA), Field Programmable Gate Arrays (FPGA), Graphical Processing Units (GPU), special purpose electronic circuits, etc., or a combination thereof. The data processing unit may be a data processing unit integrated into a pump assembly, e.g. as part of a pump control unit or as a separate data processing unit of the pump assembly. Alternatively, the data processing unit may be a data processing unit of a computing device or other data processing system external to the pump assembly.

Another aspect disclosed herein relates to a pump assembly comprising a data processing unit configured to perform the acts of an embodiment of the method described herein. The pump assembly comprises a pump and a pump motor for driving the pump. The pump may comprise an impeller. The pump assembly may further comprise a drive circuit controlling the pump motor. The data processing unit may be integrated into the drive circuit of the pump assembly, which controls the pump motor.

Accordingly, the drive circuit of the pump assembly may be suitably programmed to perform an embodiment of the process described herein. Alternatively, the data processing unit may be integrated into another control unit of the pump assembly, different from the drive circuit, or it may be a completely separate data processing unit of the pump assembly.

Yet another aspect disclosed herein relates to embodiments of a computer program configured to cause a data processing unit to perform the acts of the computer-implemented method described above and in the following. A computer program may comprise program code means adapted to cause a data processing unit to perform the acts of the computer-implemented method disclosed above and in the following when the program code means are executed on the data processing unit. The computer program may be stored on a computer-readable storage medium, in particular a non-transient storage medium, or embodied as a data signal. The non-transient storage medium may comprise any suitable circuitry or device for storing data, such as a RAM, a ROM, an EPROM, EEPROM, flash memory, magnetic or optical storage device, such as a CD ROM, a DVD, a hard disk, and/or the like.

### BRIEF DESCRIPTION OF THE DRAWINGS

The above and other aspects will be apparent and elucidated from the embodiments described in the following with reference to the drawing in which:

FIG. 1 schematically illustrates an embodiment of an apparatus for detecting hydraulic shock events in a fluid system.

FIG. 2 schematically illustrates another embodiment of an apparatus for detecting hydraulic shock events in a fluid system.

FIG. 3 schematically illustrates yet another embodiment of an apparatus for detecting hydraulic shock events in a fluid system.

FIG. 4 schematically illustrates a monitored pressure and a vibration velocity signal.

FIG. 5 schematically illustrates a process of detecting a hydraulic shock event.

FIG. 6 schematically illustrates measured and processed signals associated with an embodiment of a process of detecting a hydraulic shock event.

FIG. 7 schematically illustrates a monitored pressure, a vibration velocity signal and a monitored motor frequency.

FIG. 8 schematically illustrates a vibration velocity signal and a monitored motor frequency signal.

FIG. 9 schematically illustrates another process of detecting a hydraulic shock event.

FIG. 10 illustrates the correlation between measured vibration velocities and pressure amplitudes for hydraulic shock events of different severity.

### DETAILED DESCRIPTION

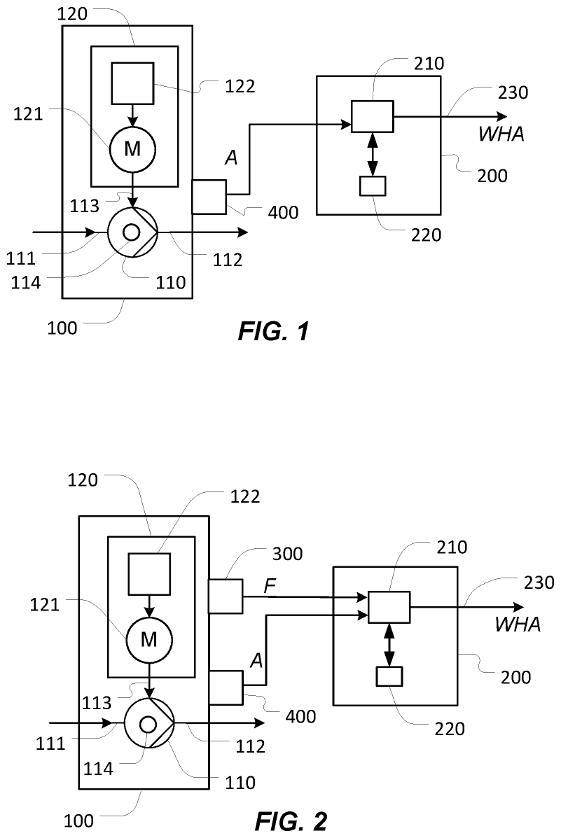

FIG. 1 schematically illustrates an embodiment of an apparatus for detecting hydraulic shock events in a fluid system. The apparatus comprises a data processing unit 200 and an accelerometer 400.

The fluid system comprises a pump assembly 100. The pump assembly 100 includes a pump 110 and a pump drive 120. The pump assembly 100 may be a centrifugal pump or a different type of pump. The pump assembly 100 has an inlet 111 for suction of water or a different fluid, such as of a different liquid. The pump assembly 100 also has an outlet 112 for providing the output flow of the pump. The pump drive 120 comprises an electrical motor 121 and a motor drive circuit 122. The motor drive circuit 122 may include a frequency converter for supplying the motor with electrical energy and/or other circuitry for controlling operation of the motor 121. The motor drive circuit 122 may be connectable to a suitable power supply (not shown) in order to supply the drive circuit, e.g. a frequency converter, with electric energy. During operation, the motor 121 drives the pump 110 causing the pump to pump fluid from the inlet 111 to the outlet 112. To this end, the motor 121 may drive a shaft 113 of the pump which, in turn, may drive an impeller 114 of the pump 110. Alternatively or additionally to the pump assembly 100, the fluid system may comprise one or more other components of the fluid system. Generally, for the purpose of the present disclosure, the term components of a fluid system refers to structural components of the fluid system other than the fluid that is being transported in the fluid system. Examples of such components include pipes, valves, boilers, pump assemblies, etc.

The accelerometer 400 is attached to the pump assembly 100 or to another component of the fluid system, or it is otherwise configured such that the accelerometer 400 detects vibrations of the pump assembly 100 or another component of the fluid system, e.g. of a pipe, a valve, etc. The accelerometer 400 is communicatively connected to the data processing unit 200 and forwards measured vibration acceleration signals as a function of time to the data processing system. The data processing unit 200 is configured to detect hydraulic shock events from the vibration acceleration signal received from accelerometer 400. An example of the processing will be described below.

The data processing unit 200 comprises a suitably programmed or otherwise configured processor 210, e.g. a microprocessor, and a memory 220. The memory 220 has stored thereon a computer program and/or data for use by the processing unit. During operation, the data processing unit 200 receives vibration acceleration signals from the accelerometer 400. To this end, the accelerometer 400 may be communicatively connected to the data processing unit 200 via a wired or wireless connection. In some embodiments, the accelerometer and the data processing unit may be integrated into a single device, e.g. in a single housing.

The accelerometer 400 may provide the vibration acceleration signals automatically or upon request by the data processing unit. The data processing unit 200 may receive the vibration acceleration signals intermittently, e.g. periodically, or (quasi-) continuously. The vibration acceleration signals may be analogue or digital. The data processing unit 200 processes the vibration acceleration signals and detects hydraulic shock events based at least on the measured accelerations as a function of time. An example of the processing will be described below.

The data processing unit 200 further comprises an output interface 230, e.g. a display or other user-interface and/or a data communications interface, an interface to a data storage device, and/or the like. The data processing system may thus be configured to output alerts responsive to detected hydraulic shock events and/or other information about detected hydraulic shock events. Additionally or alternatively, the data processing unit 200 may log the detected hydraulic shock events in memory 220.

FIG. 2 schematically illustrates another embodiment of an apparatus for detecting hydraulic shock events in a fluid system. The apparatus of FIG. 2 is similar to the apparatus of FIG. 1. In particular, the fluid system comprises a pump assembly 100 and the apparatus comprises a data processing unit 200 and an accelerometer 400, all as described in connection with FIG. 1. The apparatus of FIG. 2 differs from the embodiment of FIG. 1 only in that the apparatus of FIG. 2 further comprises a magnetic field sensor 300.

The magnetic field sensor 300 is attached to, or otherwise positioned in sufficient proximity of, the pump assembly 100 to sense the varying magnetic field, e.g. the magnetic flux, that drives the rotor of the electric motor 121 and that serves as a motor frequency signal indicative of the motor frequency, i.e. of the rotational speed of the motor. The magnetic field sensor 300 may be any suitable type of magnetic field sensor, also referred to as magnetometer. Examples of magnetic field sensors include, but are not limited to, a Hall Effect sensor, a coil sensor, a magneto-resistive sensor, a fluxmeter, and/or the like. The magnetic field sensor 300 is communicatively connected to the data processing unit 200 and forwards measured magnetic field signals as a function of time to the data processing system. The magnetic field signal may be indicative of a magnetic field strength, of a magnetic flux or of another suitable quantity indicative of the magnetic field. The magnetic field sensor 300 may be communicatively connected to the data processing unit 200 via a wired or wireless connection. In some embodiments, the magnetic field sensor and the data processing unit may be integrated into a single device, e.g. in a single housing.

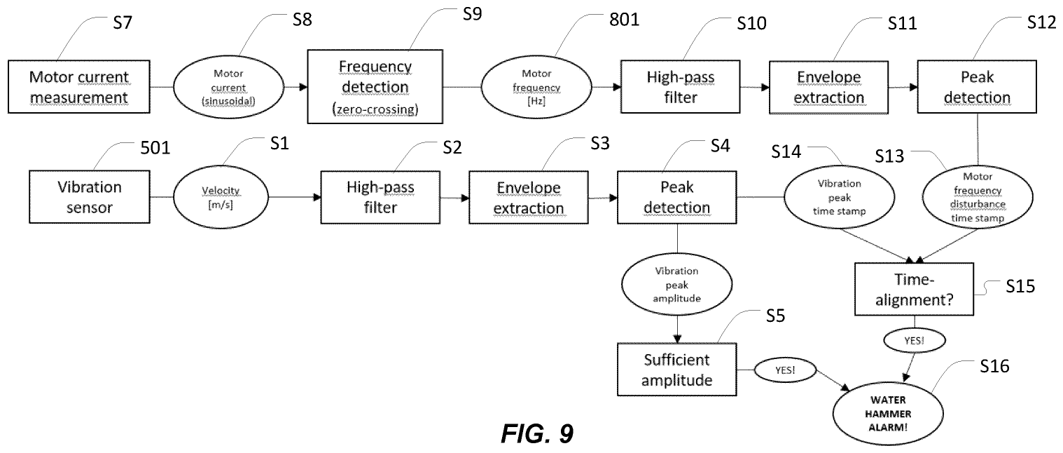

The data processing unit 200 is configured to detect hydraulic shock events from a combination of the received magnetic field signal from magnetic field sensor 300 and of the acceleration signal received from the accelerometer 400. An example of the processing will be described below with reference to FIG. 9.

In other embodiments, the apparatus may comprise another type of sensor for detecting a pump speed and/or motor frequency. Examples of such other types of sensors may include a tachometer for sensing the pump speed, e.g. for measuring the rotational speed of the shaft 113 and/or of the impeller 114. The apparatus may include such other type of sensor in addition or alternative to the magnetic field sensor 300. Generally, the apparatus may base the hydraulic shock detection on a single pump speed and/or motor frequency signal from one sensor or from multiple pump speed and/or motor frequency signals from respective sensors.

In some embodiments, the magnetic field sensor 300 and the accelerometer 400 are combined in single sensor unit having a housing that accommodates the magnetic field sensor 300 and the accelerometer 400. Optionally, the sensor unit may include one or more further sensors and/or signal processing circuitry. Examples of further sensors include a temperature sensor. The sensor unit may be communicatively connected to the data processing unit via a wired or wireless connection.

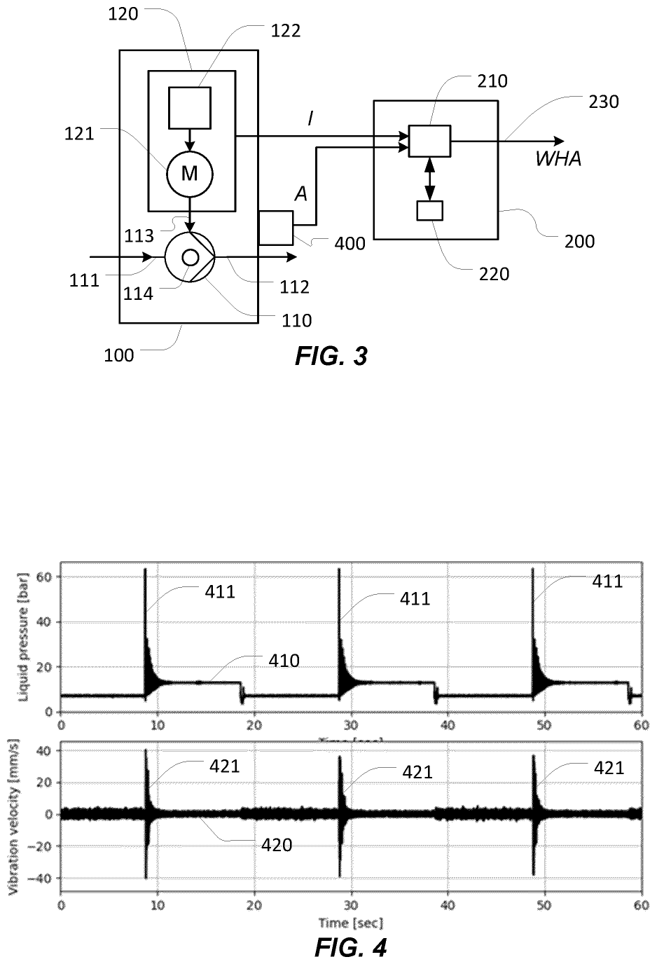

FIG. 3 schematically illustrates yet another embodiment of an apparatus for detecting hydraulic shock events in a fluid system. The apparatus of FIG. 3 is similar to the apparatus of FIG. 2. In particular, the fluid system comprises a pump assembly 100 and the apparatus comprises a data processing unit 200 and an accelerometer 400, all as described in connection with FIGS. 1 and 2. Similar to the embodiment of FIG. 2, the apparatus of FIG. 3 also comprises means for monitoring a motor frequency of the pump motor.

The apparatus of FIG. 3 differs from the embodiment of FIG. 2 only in that the data processing unit 200 receives an input signal indicative of the motor frequency directly from pump drive 120. The data processing unit may receive an input signal indicative of the drive current as a function of time, in particular indicative of the frequency of the drive current. Accordingly, in the embodiment of FIG. 3, a separate magnetic field sensor may be omitted. It will be appreciated however, that some embodiments may base the hydraulic shock detection on a combination of pump speed and/or motor frequency signals from different sources.

The apparatus of FIGS. 1-3 include an accelerometer. It will be appreciated that these embodiments may include another type of vibration sensor, e.g. a vibration velocity sensor. For example, the apparatus of each of the above embodiments may include another type of sensor in addition to, or instead of the accelerometer. Generally, the apparatus may base the hydraulic shock detection on a vibration signal from one sensor or from multiple vibration signals from respective sensors. In some embodiments, in addition to or instead of accelerometer 400, the apparatus may comprise a different type of vibration sensor, e.g. a sensor configured to output a vibration velocity signal indicative of the vibration velocity as a function of time.

In the examples of FIGS. 1-3, the data processing unit 200 is a data processing unit external to the pump assembly 100. Such an external data processing unit may be a suitably programmed computer or other data processing system external to the pump, in particular located remotely from the pump assembly. For example, the data processing unit may be a suitably programmed tablet computer, smartphone or the like. Other examples of a data processing unit may include a control system configured to control one or more components of the fluid system. In some embodiments, the external data processing unit may be embodied as a remote data processing system, e.g. a cloud-based system. The data processing system may be a distributed system including more than one computer.

In some embodiments, the data processing unit is a local data processing unit which may be integrated into the pump assembly or which may be separate from the pump assembly 100 but mountable onto or otherwise located in close proximity to the pump assembly. For example, such a local data processing unit may be configured to be communicatively connected to one or more sensors, in particular to the accelerometer and optionally to a sensor for sensing the pump speed and/or motor frequency. The local data processing unit may also be communicatively coupled to the pump drive. The local data processing unit may receive and process sensor signals from the connected sensors and, optionally, information received from the drive circuit.

The data processing unit, in particular the local data processing unit, may include a display or other type of user interface for displaying the result of the processing. For example, the data processing unit may be configured to output alerts indicative of detected hydraulic shock events, data indicative of the number, frequency and/or severity of detected shock events and/or other information pertaining to the detected shock events. A local data processing unit may further be configured to communicate with a remote data processing system, e.g. a cloud-based system, via a suitable communications network. The remote data processing system may include further functionality for data analysis, data logging, data presentation and/or the like.

In the embodiment of FIG. 3, when a local data processing unit is integrated into the pump assembly 100, e.g. accommodated into the same housing as the pump drive 120, it may receive a signal indicative of the drive current via an internal interface. Accordingly, in the embodiment of FIG. 3, if the data processing is internal to the pump drive 120, the data processing unit 200 may receive an input signal indicative of the electrical drive current from the motor drive circuit 122 via an internal interface, e.g. a data bus or another suitable wired or wireless interface. It will be appreciated that the data processing unit 200 may partly or completely be integrated with the motor drive circuit. For example, a single control circuit may be configured to control operation of the motor 121 and be configured to perform the detection of the hydraulic shock events.

When the computation is based on an accelerometer or other type of vibration sensor, or on a magnetic field sensor (or other type of sensor or other means for determining the pump speed and/or the motor frequency) and on a vibration sensor, some or all of these sensors may also be integrated into the pump or they may be external to the pump and connected to the data processing unit via a suitable wired or wireless connection. Such sensors may be provided as separate sensors or some or all of the sensors may be integrated into a single sensor unit, optionally with further sensors for sensing other quantities useful for monitoring other aspects of the fluid system.

Generally, the communication between data processing system and the sensors or the motor drive circuit may be via a direct communication link or an indirect link, e.g. via one or more nodes of a communications network. Examples of a wired connection include a local area network, a serial or parallel wired communications link, etc. Examples of wireless connections include radio frequency communications link, e.g. Wifi, Bluetooth, cellular communication, etc.

FIG. 4 schematically illustrates a monitored liquid pressure in a fluid system and a monitored vibration velocity signal. In particular, FIG. 4 shows two graphs representing measured quantities associated with a fluid system in which a liquid is pumped through pipes. The vibration velocity signal represents measured vibrations of a component of the fluid system, e.g. the pump. The quantities are measured as a function of time and the graphs represent measured values over a period of 60 s. During this time, three distinct hydraulic shock events have occurred. The upper graph 410 shows the liquid pressure of the liquid in the fluid system, as measured by a pressure sensor. As can be seen from graph 410, a hydraulic shock event is easily detectable and can be quantified by a pressure measurement in the liquid, as illustrated by the three peaks 411 in the measured pressure. Accordingly, such pressure measurements may be used to calibrate the hydraulic shock detection based on monitored vibration sensor signals, optionally in combination with measured pump speed and/or motor frequency signals, as described herein, e.g. in order to choose thresholds and/or other parameters of the detection. For example, such measurements may be performed for a given pump or type of pumps when connected to a fluid system test bed.

The lower graph 420 illustrates a vibration velocity signal obtained from measured vibration acceleration signals by an accelerometer positioned on the pump. As can be seen in FIG. 4, the hydraulic shock events can also be detected as distinct peaks 421 in the obtained vibration velocity signal, as each hydraulic shock event results in a distinct vibration shock.

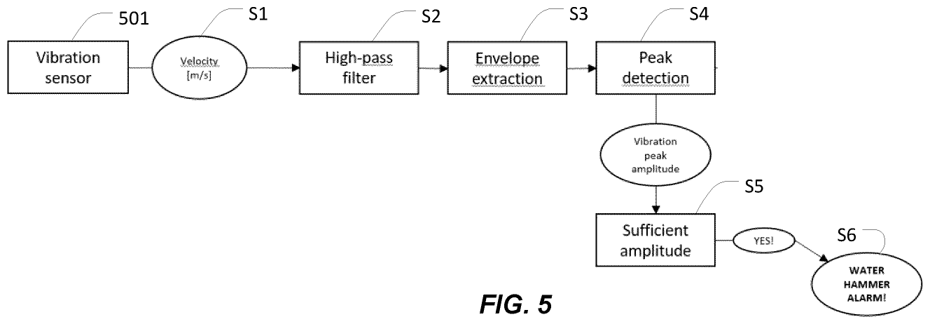

FIG. 5 schematically illustrates a process of detecting a hydraulic shock event.

Generally, in initial step S1, the process obtains a vibration velocity signal from the vibration sensor signal output by a vibration sensor 501. The vibration velocity signal is indicative of a velocity of the sensed vibration as a function of time.

Generally, vibrations may be measured by means of a suitable vibration sensor 510 on the pump structure or on another structural component of the fluid system. The vibration sensor may be an accelerometer or another type of vibration sensor, e.g. a vibration velocity sensor or a displacement sensor. It is also possible to obtain a vibration velocity signal from for instance a microphone (measuring sound waves) or a high-speed camera. The inventors have realised that use of a vibration velocity signal provides a more reliable hydraulic shock detection. Accordingly, regardless of the measurement method and the units by which the measured vibrations are expressed, the process obtains a vibration velocity signal from the measured vibration sensor signal.

To this end, the process may receive the vibration velocity signal directly from the vibration sensor, in particular when the vibration sensor is a vibration velocity sensor that is operable to sense vibration velocity. Alternatively, the vibration sensor may output a vibration sensor signal other than a vibration velocity signal. In particular, the vibration sensor may be an accelerometer that outputs a vibration acceleration signal indicative of sensed accelerations. In such embodiments, obtaining the vibration velocity signal includes receiving the vibration sensor signal and transforming the received vibration sensor signal into a vibration velocity signal. When the vibration sensor signal is a vibration acceleration signal, the transforming includes an integration with respect to time.

The vibration sensor signal may be an analogue or digital signal, for example, the digital signal may represent sampled measurement values, sampled at a suitable sampling rate.

The process then processes the obtained vibration velocity signal to identify peaks in the received obtained vibration velocity signal. Based on the identified peaks, the process determines whether a hydraulic shock event has occurred. For example, this determination may be based on the amplitude of the peak and or on a more detailed analysis of the peak envelope.

More specifically, in step S2 of the process of FIG. 5, the process performs a high-pass filtering of the vibration velocity signal in order to filter out slow variations of the measured vibrations. It will be appreciated that, in other embodiments, the high-pass filtering may be omitted or the high-pass filtering may be performed on the received vibration acceleration signal or otherwise at another point of the signal processing pipeline. In some embodiments, the process may include another type of filtering in addition or alternatively to the high-pass filtering.

In subsequent step S3, the process performs an envelope extraction of the, optionally high-pass filtered, vibration velocity signal, resulting in an envelope signal representing a vibration velocity amplitude signal, i.e. the time-dependent amplitude of the vibration velocity. Again, in some embodiments, the envelope extraction may be omitted and other techniques for detecting peaks in the vibration velocity signal may be employed which do not rely on an envelope signal.

In subsequent step S4, the process performs peak detection in the vibration velocity envelope signal and computes the peak amplitude of any detected peak, e.g. using suitable technique for peak detection in a time-dependent signal known as such in the art. For example, the peak amplitude may be computed relative to a baseline. To this end, the process may detect a baseline from the vibration velocity envelope signal, e.g. as an average stable signal level determined over a suitable time period, e.g. over the order of minutes or hours. Alternative or in addition to the peak amplitude, another measure of the magnitude of a peak or otherwise of the significance of the peak may be employed.

In step S5, the process compares the computed peak amplitude of the vibration velocity envelope with a predetermined threshold. The threshold may be configurable so as to allow tuning the sensitivity of the hydraulic shock detection. For example, the tuning may be made on a test bed where hydraulic shock events can be induced and reference measurements of liquid pressure can be performed. If the peak amplitude exceeds the threshold, the process proceeds at step S6 and creates a hydraulic shock alert. The hydraulic shock alert may be output in a variety of ways, e.g. as an alert on a user-interface, e.g. as an acoustic and/or visible alert, or as an alert signal that is forwarded to a remote system for user output, logging and/or the like, and/or by directly logging the alert. The process may also output the peak amplitude and/or another computed measure of the severity of the detected hydraulic shock event.

It will be appreciated that a number of variations may be made to the process. For example, issuance of a hydraulic shock alert may be conditioned on alternative or additional trigger conditions, e.g. base on one or more other features of the detected peak, e.g. a computed area under the peak, attack and/or decay characteristics of the peak and/or the like. Alternatively or additionally, the process may issue different types of alerts, e.g. representing different levels of severity. For example, the process may compare the peak amplitude to two or more different thresholds and issue different types of alerts responsive to which thresholds have been exceeded. Yet further, the high-pass filtering and/or the envelope extraction may be omitted or replaced by a different type of filtering or processing.

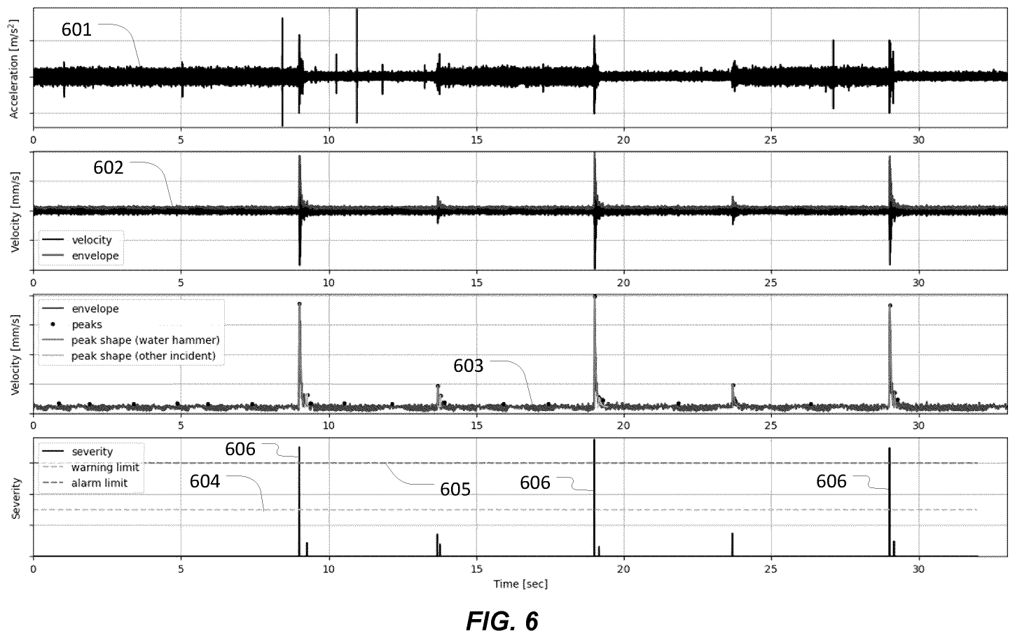

FIG. 6 illustrates an example of measured vibration signals and the signal processing involved in the example of the detection process of FIG. 5.

In particular, in the example of FIG. 6, the vibration sensor, on which the detection was based, was an accelerometer mounted on a pump assembly of a fluid system exposed to hydraulic shock events. The uppermost graph 601 illustrates the vibration acceleration signal received from the accelerometer during a period of about 32 s. Graph 602 shows the vibration velocity signal and the corresponding envelope obtained by transforming the received vibration acceleration signal 601 with respect to time and by extracting the envelope of the oscillating vibration velocity signal. As can be seen from a comparison between graphs 601 and 602, the vibration acceleration signal includes considerably more peaks than the vibration velocity signal, not all of which actually result from hydraulic shock events. Accordingly, basing the hydraulic shock event detection on the vibration velocity signal has been found to result in a more reliable detection.

Graph 603 illustrates the extracted envelope signal of the vibration velocity signal where detected peaks are indicated by dots. An analysis of the peak shape, in particular of the peak amplitude, may be used to distinguish between hydraulic shock events and other incidents causing vibrations of the pump assembly.

In particular, as illustrated in the bottommost diagram of FIG. 6, the peak amplitudes of the detected peaks may be used as an indicator of the severity of a detected hydraulic shock event. Comparing the amplitude to one or more thresholds may thus be used to create respective types of hydraulic shock event alerts. In the example of FIG. 6, the peak amplitudes have been compared with two thresholds 604 and 605, respectively. Only if a detected peak exceeds at least the lower threshold 604, a hydraulic shock warning is issued. If a peak amplitude exceeds both thresholds 604 and 605, as is e.g. the case for detected peaks 606, an actual hydraulic shock alarm may be issued, e.g. in the form of an audible alarm or otherwise emphasized alert.

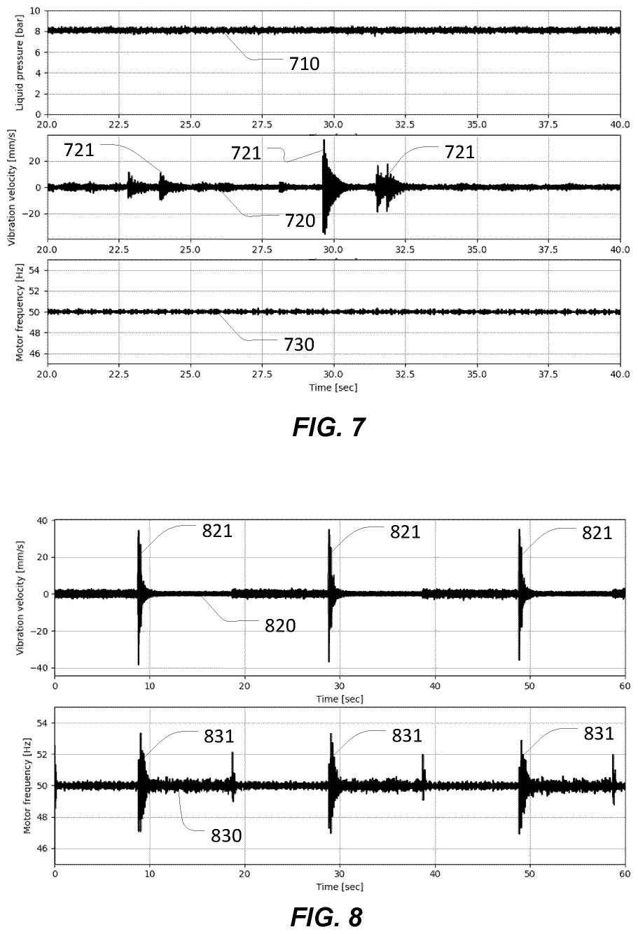

Accordingly, a hydraulic shock event can be detected by vibration analysis alone. However, the inventors have also realised that a sudden rise in amplitude of the vibration velocity signal with following ringing out is not always a unique signature for hydraulic shock events. Other events may cause a similar vibrational pattern, e.g. hitting the pump with the palm of your hand or other types of sudden mechanical impact onto a structural component of the fluid system. Consequently, a hydraulic shock detection based solely on vibration analysis may be prone to errors in the form of false positive detections. This is illustrated in FIGS. 7 and 8.

In particular, FIG. 7 schematically illustrates a monitored liquid pressure signal 710 and corresponding monitored vibration velocity signal 720. FIG. 7 further shows a measured motor frequency signal 730. In particular, the graphs represent the respective measured quantities associated with a fluid system in which a liquid is pumped through pipes. The quantities are measured as a function of time and the graphs represent measured values over a period of 40 s. During the measurement period, the pump was excited by applying physical force to the pump structure. The vibrational patterns 721 in the centre plot 720 are very similar to the observed peaks of a hydraulic shock event (e.g. the peaks in graph 602 of FIG. 6). However, in this example, the measured liquid pressure signal 710 reveals that there are no shock waves in the liquid.

FIG. 7 further shows a measured signal indicative of the motor frequency of the motor driving the pump that pumps the fluid through the fluid system. In particular, graph 730 shows the measured frequency of the variation of the magnetic field driving the motor as measured by a flux sensor attached to the pump assembly. As can be seen, the measured motor frequency is substantially stable over the measurement period despite the excitation of the pump by applying physical force.

FIG. 8 schematically illustrates a monitored vibration velocity signal and a monitored motor frequency. As above, FIG. 8 shows two graphs representing the measured quantities associated with a fluid system in which a liquid is pumped through pipes. The quantities are measured as a function of time and the graphs represent measured values over a period of 60 s. During this time, three distinct hydraulic shock events have occurred. The upper graph 820 is similar to graph 602 of FIG. 6 in that graph 820 illustrates a vibration velocity signal obtained from accelerometer signals of an accelerometer positioned on the pump during a period of time where three hydraulic shock events have been detected as distinct peaks 821 in the vibration velocity signal.

The lower graph 830 illustrates a measured motor frequency of the electrical motor driving the pump. The motor frequency was detected by a magnetic flux sensor attached to the pump assembly. As can be seen from FIG. 8, the motor frequency 830 experiences shock-like disturbances 831 very similar to the vibrational peaks 821 seen in the corresponding vibration signal 820.

Accordingly, the inventors have found that the measured motor frequency, or a measure of the pump speed and/or shaft speed driving the pump, can be used as an indicator signal for detecting hydraulic shock events. In particular, the measured motor frequency and/or pump speed can be used as a secondary indicator signal in order to validate that a vibrational shock measured by an vibration sensor is indeed caused by a pressure impulse in the liquid and not caused by physical force applied to the pump structure or connected piping.

FIG. 9 schematically illustrates another process of detecting a hydraulic shock event. The process of FIG. 9 bases the hydraulic shock detection on a measured vibration signal and on a measured signal that is indicative of the drive current of the motor driving a pump of the fluid system.

To this end, in steps S1 through S5, the process obtains a vibration velocity signal from a signal received from a vibration sensor 501, processes the obtained vibration velocity signal and detects peaks in the vibration velocity signal, all as described in connection with the corresponding steps of the process of FIG. 5. As discussed above, in alternative embodiments, other types of vibration sensors and/or other specific processing steps may be employed to obtain a vibration velocity signal and detect peaks in the vibration velocity signal.

The process of FIG. 9 differs from the process of FIG. 5 in that the process of FIG. 9 only issues a hydraulic shock alert when at least two trigger conditions are fulfilled. To this end, at step S5, if the computed peak amplitude of the vibration velocity signal exceeds the threshold, instead of directly issuing a hydraulic shock alert, the process of FIG. 9 merely sets a first trigger condition to TRUE.

The process of FIG. 9 then uses an additional trigger condition for determining whether to issue a hydraulic shock alert. To this end, the process concurrently obtains and processes a measured input signal indicative of a pump speed and/or a motor frequency of a pump assembly of the fluid system. The process receives the input signal as a function of time. The input signal may be an analogue or digital signal, for example, the digital signal may represent sampled measurement values, sampled at a suitable sampling rate.

In the present example, in step S7, the process measures the drive current of the motor. It will be appreciated that other embodiments may use other types of measurements indicative of the pump speed and/or motor frequency, e.g. a signal indicative of the shaft speed (or shaft frequency) of the shaft driving the pump, or another input signal indicative of the motor frequency, in particular a signal indicative of the varying magnetic field driving the rotor of the motor. The motor frequency and the pump speed are closely related as it is the motor which is driving the shaft. Apart from a minor slip which can occur in some motor constructions, the shaft speed and the motor frequency will be the same or substantially be the same. Thus in this regard, shaft speed and motor frequency may both be suitable measures for detecting hydraulic shock events.

The shaft speed can be measured or estimated by several means. This may for instance be done by vibrational measurements on the pump structure or by means of a tachometer measuring directly on the shaft. The motor frequency can also be measured in several ways, e.g. by measuring the motor current directly in the motor, or by measuring the magnetic field of the motor, in particular the magnetic field, e.g. with a coil mounted in the vicinity of the motor or by means of another type of magnetic field sensor.

The process then processes the received input signal to identify peaks in the signal representing the pump speed and/or motor frequency. Based on the identified peaks, the process determines a further indicator, in addition to the detected peaks in the vibration velocity signal, indicative of whether a hydraulic shock event has occurred. For example, this determination may be based on the amplitude of the peak and or on a more detailed analysis of the peak envelope.

A specific example of the process will now be described with reference to FIG. 9. In this example, in step S7, the process measures the electrical drive current driving the pump motor. The measurement may be performed by a suitable sensor or be determined by the motor drive circuit. In any event, in step S8, the drive current is fed from the sensor or motor drive circuit to the data processing unit performing the hydraulic shock detection process, i.e. the data processing unit receives the signal indicative of the motor drive current as an input. In step S9, the process detects the frequency of the drive current. In particular, the drive current is normally a sinusoidal signal and the process may perform a detection of zero crossings of the signal to derive the frequency of the drive current as a function of time, which may then serve as a measure 901 of the motor frequency as a function of time. As mentioned above, alternatively, the process may receive another measure of the pump speed and/or motor frequency as a function of time as the input for the hydraulic shock detection. Accordingly, other embodiments may include alternative or additional pre-processing steps in order to derive a suitably signal indicative of the pump speed and/or motor frequency as a function of time.

Optionally, in subsequent step S10, the process performs a high-pass filtering of the frequency signal (or of another measure of the pump speed and/or motor frequency) in order to filter out slowly varying changes of the motor frequency so as to facilitate the detection of fast/sudden fluctuations of the motor frequency and/or pump speed. It will be appreciated that, in other embodiments, the high-pass filtering may be omitted or performed at another point of the signal-processing pipeline. In some embodiments, the process may include another type of filtering in addition or alternatively to the high-pass filtering.

In subsequent step S11, the process may perform an envelope extraction of the, optionally high-pass filtered, frequency signal, resulting in an envelope signal. Again, in some embodiments, the envelope extraction may be omitted and other techniques for detecting peaks in the motor frequency signal (or in a signal representing the pump speed) may be employed which do not rely on an envelope signal.

In subsequent step S12, the process performs peak detection in the envelope signal, e.g. using a suitable technique for peak detection in a time-dependent signal known as such in the art. In some embodiments, the process also computes the peak amplitude of a detected peak and compares the computed peak amplitude with a predetermined threshold. In such an embodiment, only peaks having an amplitude exceeding the threshold may be registered as an indicator for a hydraulic shock event. The threshold may be configurable, thus allowing tuning the sensitivity of the hydraulic shock detection. For example, the tuning may be made on a test bed where hydraulic shock events can be induced and reference measurements of liquid pressure can be performed. Alternatively or additionally, other criteria for the detection of peaks that are indicative of a hydraulic shock event may be chosen.

In step S13, if the process has detected a peak in the frequency signal, or at least a peak fulfilling the chosen criteria, the process records a motor frequency disturbance time stamp indicative of the time at which the peak in the frequency signal has occurred.

Additionally, if the process at step S4 has detected a peak in the vibration velocity signal, or at least a peak that fulfils one or more criteria, such as a peak of at least a minimum magnitude, e.g. as determined in step S5, the process proceeds at step S14 and records a vibration peak time stamp indicative of the time at which the peak in the vibration velocity signal has occurred.

At step S15, the process compares the time stamps of the detected peaks in the motor frequency signal (i.e. the peaks detected in step S12) and of the detected peaks in the vibration velocity signal (i.e. the peaks detected in step S4). If corresponding peaks are detected in both signals in appropriate temporal alignment, the process sets a second trigger condition to TRUE. In particular, the process may set the second trigger condition to TRUE only if there are detected peaks in both signals that are temporally aligned such that they are caused by the same event. It will be appreciated that the temporal alignment does not necessarily require the peaks to be simultaneous but may correspond to a predetermined delay between the two peaks, and/or to the peaks occurring within a suitable, e.g. predetermined, time window of each other. The delay may depend on the location of the vibration sensor relative to the pump, on the speed at which a shock wave propagates in the fluid being pumped, on the properties of the pump, etc. The proper delay may be determined during an initial calibration of the apparatus or it may be set to a default value or to a suitable time window covering a range of delays that may be expected in typical configurations.

If both trigger conditions are fulfilled, i.e. if a vibration peak of sufficient amplitude has been detected at step S5 and if the vibration peak has been detected in temporal alignment with a corresponding peak in the motor frequency signal (as determined in step S15), the process proceeds at step S16 and outputs a hydraulic shock alert. The hydraulic shock alert may be output in a variety of ways, e.g. as described in connection with FIG. 5.

It will be appreciated that a number of variations may be made to the process. For example, issuance of a hydraulic shock alert may be conditioned on alternative or additional trigger conditions, e.g. based on one or more other features of the detected peak in the vibration signal, e.g. a computed area under the peak, attack and/or decay characteristics of the peak and/or the like. Alternatively or additionally, the process may issue different types of alerts, e.g. representing different levels of severity. For example, the process may compare the peak amplitude to two or more different thresholds and issue different types of alerts responsive to which thresholds have been exceeded. Yet further, the high-pass filtering and/or the envelope extraction may be omitted or replaced by a different type of filtering or processing. Yet further, in some embodiments, the process may condition the issuance of a hydraulic shock alert on detected properties, e.g. a detected amplitude, of the peaks detected in the motor frequency signal alternatively or additionally to using the detected properties of the peaks in the vibration signal.

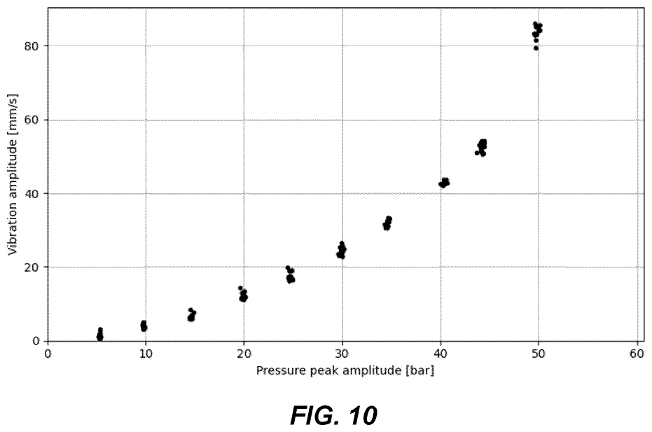

FIG. 10 illustrates the correlation between measured vibration velocities and pressure amplitudes for hydraulic shock events of different severity. As can clearly be seen from FIG. 10, there is a strong correlation between the measured vibration velocities and pressure amplitudes for hydraulic shock events of different severity. The measurements shown in FIG. 10 are for a particular fluid system. It will be appreciated that the absolute values of the vibration measurements may vary from system to system, there will be a clear correlation to the corresponding pressure peaks, thus allowing for a reliable assessment of the severity of hydraulic shock events which may also facilitate the classification of hydraulic shock events based on their severity.

Embodiments of the method described herein can be implemented by means of hardware comprising several distinct elements, and/or at least in part by means of a suitably programmed microprocessor. In the apparatus claims enumerating several means, several of these means can be embodied by one and the same element, component or item of hardware. The mere fact that certain measures are recited in mutually different dependent claims or described in different embodiments does not indicate that a combination of these measures cannot be used to advantage. It should be emphasized that the term “comprises/comprising” when used in this specification is taken to specify the presence of stated features, elements, steps or components but does not preclude the presence or addition of one or more other features, elements, steps, components or groups thereof.

1. An apparatus for detecting hydraulic shock events in a fluid system, the apparatus comprising a vibration sensor operable to output a vibration sensor signal indicative of sensed vibrations of one or more components of the fluid system, and a processing unit configured to:
obtain a vibration velocity signal from the vibration sensor signal, the vibration velocity signal being indicative of a vibration velocity of the one or more components of the fluid system;
detect one or more peaks in the vibration velocity signal; and
classify one or more of the detected peaks as a hydraulic shock event.

2. An apparatus according to claim 1, wherein the processing unit is further configured to compute a measure of severity of the hydraulic shock event from the vibration velocity signal.

3. An apparatus according to claim 1, wherein the vibration sensor is a vibration velocity sensor configured to sense vibration velocity, wherein the vibration sensor signal represents a vibration velocity signal and wherein obtaining the vibration velocity signal comprises receiving the vibration velocity signal from the vibration velocity sensor.

4. An apparatus according to claim 2, wherein the vibration sensor is an accelerometer operable to sense accelerations of one or more components of the fluid system, wherein the vibration sensor signal represents a vibration acceleration signal and wherein obtaining the vibration velocity signal comprises receiving the vibration acceleration signal and transforming the received vibration acceleration signal into a vibration velocity signal.

5. An apparatus according to claim 1, wherein the processing unit is configured to classify one or more of the detected peaks as a hydraulic shock event responsive to the one or more of the detected peaks fulfilling one or more trigger criteria, in particular a magnitude of the one or more of the detected peaks exceeding a threshold.

6. An apparatus according to claim 1, wherein obtaining the vibration velocity signal comprises performing an envelope computation to obtain a vibration velocity amplitude signal indicative of an amplitude of an oscillating vibration velocity as a function of time; and wherein the processing unit is further configured to:
detect one or more peaks in the vibration velocity amplitude signal,
compute respective magnitudes of the detected one or more peaks, and
classify one or more of the detected peaks as a hydraulic shock event responsive to the computed magnitude exceeding a threshold.

7. An apparatus according to claim 1, wherein the fluid system comprises a pump assembly, the pump assembly comprising a pump and a pump motor, wherein the apparatus further comprises means for monitoring a pump speed of the pump and/or a motor frequency of the pump motor, and wherein the processing unit is configured to:
detect a variation in the monitored pump speed and/or motor frequency; and
classify one or more of the detected peaks in the vibration velocity signal as a hydraulic shock event, responsive to detecting a corresponding variation in the monitored pump speed and/or motor frequency.

8. An apparatus according to claim 7, wherein the processing unit is configured to classify a detected peak in the vibration velocity signal as a hydraulic shock event responsive to the detected peak in the vibration velocity signal having a predetermined temporal relationship with the detected variation in the monitored pump speed and/or motor frequency.

9. An apparatus according to claim 7, wherein the processing unit is configured to:
detect fluctuations in a pump speed and/or motor frequency signal indicative of the monitored speed, in particular in a filtered pump speed and/or motor frequency signal,
compute a magnitude of the detected fluctuation, and
classify one or more of the detected peaks in the vibration velocity signal as a hydraulic shock event responsive to detecting a corresponding variation in the monitored speed, the detected variation having a computed magnitude exceeding a threshold.

10. A computer-implemented method for detecting hydraulic shock events in a fluid system, the method comprising:
obtaining a vibration velocity signal, the vibration velocity signal being indicative of a vibration velocity of vibrations of one or more components of the fluid system;
detecting one or more peaks in the vibration velocity signal; and
classifying one or more of the detected peaks as a hydraulic shock event.
